(19) United States
(12) Patent Application Publication
(10) Pub. No.: US 2011/0217615 A1
(43) Pub. Date: Sep. 8, 2011

(54) FUEL CELL STABILISATION SYSTEM AND METHOD

(75) Inventors: Rex Graham Smith, Victoria (AU); Andrew Bryce Dickson, North Shore City (NZ)

(73) Assignee: Ceramic Fuel Cells Limited, Victoria (AU)

(21) Appl. No.: 12/997,484

(22) PCT Filed: Jun. 12, 2009
(86) PCT No.: PCT/AU2009/000749

§ 371 Date: May 20, 2011

(30) Foreign Application Priority Data
Jun. 13, 2008 (AU) 2008903015

(51) Int. Cl. H02J 1/00; H01M 8/24

(52) U.S. Cl. 429/452; 307/48

(57) ABSTRACT

A fuel cell stabilisation system for stabilising the supply of electrical power from a fuel cell stack (101) to a DC bus (104), including: a DC power supply (108); and a control (112) configured to enable the DC power supply (108) to supply electrical power to the DC bus (104).

### FIELD

The present invention relates to a system and method for stabilising the supply of electrical power from a fuel cell stack.

### BACKGROUND

Fuel cells convert gaseous fuels such as hydrogen, natural gas and gasified coal, via an electrochemical process, directly into electricity. A fuel cell continuously produces power when supplied with fuel and oxidant, normally air. A typical fuel cell consists of an electrolyte in contact with anode and cathode electrodes (mainly electronic conductors). During operation there is a large difference in pressure across the electrolyte of a species that can be ionically transferred from one side of the electrolyte to the other. Any ions that are transferred are charged/discharged by catalytic activity at the electrodes and this ionic transfer is opposed by the accumulation of charge on the electrodes. The closing of an external circuit allows a current to flow through the electrolyte.

A fuel cell system typically includes a plurality of fuel cells in a fuel cell stack and additional subsystems to regulate fuel flow and the generated electrical power.

During operation of a fuel cell system it is desirable to avoid instability in the current being supplied from the fuel cell to its electrical loads, especially the extremes of under-current and over-current operating conditions. These conditions may arise due to imbalances between the maximum electrical current that the fuel cell system can supply and the actual electrical load demands imposed on the system.

During normal operation of a fuel cell system, an over-current occurs when the current demand placed on the system exceeds the maximum current that may be drawn from the system under the prevailing operating conditions. An over-current condition could occur, for example, as a result of an increase in the external electrical load on the system, or due to the transient response of an AC inverter when the fuel cell system supplies electricity to an AC power grid and the demands of the grid surge dramatically, or due to the transient response of a DC/DC converter when the fuel cell supplies a DC load to, for example, a telecommunications system. Alternatively, an over-current condition may occur when the external impedance load remains constant but the instantaneous capacity of the fuel cell system to supply electricity is reduced, for example, due to a sudden decrease in the concentration of reactive species supplied to the electrodes of the fuel cell. Irrespective of cause, an over-current condition is undesirable since it can lead to damage of a fuel cell due to oxidation of the anode material. In theory oxidation of the anode is reversible but volumetric changes associated with oxidation can present significant problems in practice.

Existing systems and methods of protecting fuel cells from instability and over-current conditions include safety contacts. Safety contacts may electrically isolate the fuel cell stack from an electrical system drawing too much current. The term “safety contact” may mean a logical manner of disconnecting the functionality of the connected device(s) as well as a physical or semiconductor isolation device. However, existing systems and methods of using safety contacts may result in reduced electrical efficiency. In addition, existing systems and methods may be slow, or may cause transient voltage and current levels, thereby potentially damaging the fuel cell stack and ancillary support systems. Fuel cell control systems may also be complex and therefore expensive to implement.

An under-current condition arises when the instantaneous current available to be drawn from the fuel cell system exceeds the actual current drawn by some external load. The condition may occur when there is a sudden reduction in the current drawn from the fuel cell system, for example, due to an open circuit in an electrical load. An open circuit may occur for fuel cell systems connected via an inverter to an AC power grid if the inverter cuts off, for example, due to fluctuations in the state of the AC power. Alternatively, an under-current condition may occur when the concentration of reactive species supplied to the fuel cell stack for electricity generating reactions exceeds the concentration required to meet the electrical load on the stack output.

An under-current condition is undesirable since it can impair operating efficiency and thermal management of the fuel cell system, particularly in the non-electric power production sections commonly referred to as the “balance of plant”. The balance of plant for solid-oxide fuel cell (SOFC) systems includes fuel processors (e.g. reformers), heat exchangers (to convey heat between cold air and fuel, and hot exhaust), oxidisers for residual unburnt fuel cell fuel, and system heat-up burners. Control systems may be used in order to regulate the operating characteristics of a fuel cell system. These can be effective in response to an over-current condition. However, such remedial response tends to be slow and it can be ineffective especially if an under-current condition is transient. As noted above, control systems may also be complex and therefore expensive to implement.

It is generally desirable to overcome or ameliorate one or more of the above-described difficulties, or at least provide a useful alternative.

### SUMMARY

Accordingly, one embodiment the present invention provides a fuel cell stabilisation system for stabilising the supply of electrical power from a fuel cell stack to a DC bus within a selected operating range, including:
a DC power supply; and
a control configured to enable the DC power supply to supply electrical power to the DC bus based on a stabilisation signal representing the supply of electrical power being outside the selected operating range.

The DC bus permits current to be drawn from the fuel cell stack by some external load. If, under the prevailing operating conditions of the stack, the current power demand associated with the external load exceeds the instantaneous electrical output of the stack, an over-current condition arises which means the supply of electrical power from the fuel cell stack is outside a selected operating range, selected in accordance with the parameters of the fuel cell system. However, in accordance with this embodiment, over-current is avoided by the use of an independent DC power supply that is configured to supply electricity to the DC bus under the governance of the control. Thus, damage to the fuel cell is avoided by prevention of an over-current condition. Preferably, this extra supply of electricity comes from an AC power grid to which the independent DC power supply is attached.

The stabilisation system may be either voltage-controlled, by measuring the voltage of the DC bus (or an equivalent voltage), or current-controlled, by measuring the current flow from the fuel cell (or an equivalent current).

In a voltage-controlled stabilisation system, the control may include:
a bus voltage sensor configured to sense a DC bus voltage on the DC bus representative of the supply of electrical power;
a comparator configured to compare the DC bus voltage to at least one selected set-point voltage defining the selected operating range, to generate the stabilisation signal; and
a variable control (also known as a variable contact), controlled by the stabilisation signal of the comparator, configured to control the supply of electrical power to the DC bus.

With such a system, the decision as to when electricity is to be supplied from the DC power supply is made by comparing the instantaneous bus voltage, using the bus voltage sensor, and a turn-on set-point voltage. The set-point voltage is associated with the selected operating range and is predetermined depending on the characteristics and operating conditions of the fuel cell stabilisation system, particularly the level of bus voltage that corresponds to an over-current condition in the fuel cell. If the bus voltage falls below the predetermined set-point, this indicates that over-current is in danger of occurring, and the DC power supply is then connected to the DC bus to provide an alternative source of electricity; providing this extra electricity also stabilises the voltage of the DC bus. At a later point in time, when the stack is able to again supply sufficient power, either because of a change in electrical load or a change in fuel flow to the stack, the voltage of the DC bus will rise again, above the selected turn-on set-point for the DC power supply (i.e., back into the selected operating range), and the DC power supply will then cease to supply power to the DC bus. The connection of the DC power supply to the DC bus is through a variable control (also known as a variable contact) which may increase and decrease the power supplied to the DC bus in a substantially linear fashion. This could be by means of a pulse width controller.

The present invention also provides a method for stabilising the supply of electrical power from a fuel cell stack to a DC bus within a selected operating range, which method includes:
detecting a DC bus voltage on the DC bus; and
increasing an electrical power flow to the DC bus from a DC power supply as required, based on a stabilisation signal representing the supply of electrical power being outside the selected operating range.

In a current-controlled stabilisation system, the control includes:
a fuel cell current sensor configured to sense a fuel cell electrical current supplied by the fuel cell stack representative of the supply of electrical power;
a comparator configured to compare the fuel cell electrical current to at least one selected set-point current defining the selected operating range, to generate the stabilisation signal; and
a variable control, controlled by the stabilisation signal of the comparator, configured to control the supply of electrical power to the DC bus.

In a current-controlled embodiment of the present invention, instead of sensing the voltage of the DC bus, the current drawn from the fuel cell stack is measured by a current sensor; consequently, the turn-on and turn-off set-points associated with the selected operating range of the independent DC power supply are current set-points rather than voltage set-points. The current sensor can directly detect the onset of an over-current condition. When an over-current condition occurs, or the current being drawn from the fuel cell stack is increasing and beginning to approach an over-current condition, the independent DC power supply is turned on, thereby providing an alternate source of power to the DC bus, to reduce the current load on the fuel cell. The turn-on set-point current for the DC power supply is determined with reference to the characteristics and operating conditions of the fuel cell system.

The present invention also provides a method for stabilising the supply of electrical power from a fuel cell stack to a DC bus within a selected operating range, which method includes:
detecting a fuel cell current being drawn from the fuel cell stack by the DC bus; and
increasing an electrical power flow to the DC bus from a DC power supply as required, based on a stabilisation signal representing the supply of electrical power being outside the selected operating range.

Preferably the amount of electricity supplied to the DC bus by the independent DC power supply is controlled by a variable control, which connects the DC power supply and the DC bus. Typically, the DC power supply is powered at start-up by a power grid. The power grid is a source of electrical power external to the fuel cell system. Typically, a DC-to-AC inverter is electrically connected to the DC bus for exporting electrical power from the fuel cell stack. Preferably, an EMC filter is electrically connected to the DC bus for reducing electromagnetic noise and transient voltages on the DC bus.

The problem of excess current being drawn from the fuel cell system may be solved either by providing an alternate source of current, e.g. the DC power supply described above, or by reducing the electrical load on the DC bus itself. Certain of the electrical loads on the DC bus may be described as “parasitic” or housekeeping elements that require electrical power for operation of ancillary components associated with the fuel cell system. These elements are supplied via a housekeeping supply from the DC bus during normal operation of the fuel cell system. If a situation arises in which excess current (i.e., outside the selected operating range) is being drawn from the fuel cell stack by the various loads on the DC bus, the amount of power drawn by the housekeeping elements can be reduced by disconnecting (or partially disconnecting) them from the DC bus. This disconnection is effected by a variable housekeeping control that limits the supply of current from the DC bus into the housekeeping supply. Under normal operating conditions, the housekeeping control allows full power into the housekeeping supply. However, when the case occurs that too much current is being drawn from the fuel cell, the housekeeping supply output is at least partially restricted.

The present invention also provides a fuel cell stabilisation system for stabilising the supply of electrical power from a fuel cell stack to a DC bus within a selected operating range, including a control configured to limit electrical power drawn from the DC bus by a housekeeping supply, which is configured to power one or more housekeeping elements, based on a stabilisation signal representing the supply of electrical power being outside the selected operating range.

In a voltage-controlled stabilisation system, the control includes:
a bus voltage sensor configured to sense a DC bus voltage on the DC bus representative of the supply of electrical power;
a comparator configured to compare the DC bus voltage to at least one selected set-point voltage defining the selected operating range, to generate the stabilisation signal; and
a variable control, controlled by the stabilisation signal of the comparator, configured to limit electrical power drawn from the DC bus by the housekeeping supply.

The housekeeping connection controller detects that too much power is being drawn when the voltage of DC bus falls below a selected set-point associated with the selected operating range. This housekeeping set-point is selected in advance and depends on the characteristics and operating conditions of the fuel cell system and the stabilisation system. Once the DC bus voltage falls below this set-point value, the housekeeping power supply is at least partially disconnected from the DC bus, thereby reducing the load on the DC bus and therefore the current load on the fuel cell as required. By reducing the current drawn from the DC bus, the voltage may then be stabilised. Furthermore, as operating conditions change and the fuel cell stack is thereafter able to supply sufficient power, the voltage on the DC bus will rise above the housekeeping set-point, and the housekeeping elements will recommence drawing power from the DC bus. The connection of the housekeeping supply to the DC bus is through a variable control that can decrease and increase the power drawn from the DC bus substantially linearly.

In a current-controlled system, the control includes:
a fuel cell current sensor configured to sense a fuel cell electrical current supplied by the fuel cell stack representative of the supply of electrical power;
a comparator configured to compare the fuel cell electrical current to at least one selected set-point current defining the selected operating range, to generate the stabilisation signal; and
a variable control, controlled by the stabilisation signal of the comparator, configured to limit electrical power drawn from the DC bus by the housekeeping supply.

The present invention also provides a method for stabilising the supply of electrical power from a fuel cell stack to a DC bus within a selected operating range, which method includes:
detecting a DC bus voltage on the DC bus connected to the fuel cell stack; and
reducing an electrical power flow from the DC bus to a housekeeping power supply as required, based on a stabilisation signal representing the supply of electrical power being outside the selected operating range.

In a current-controlled embodiment of the present invention, instead of sensing the voltage of the DC bus, the current drawn from the fuel cell stack is measured by a current sensor; consequently, the turn-on and turn-off set-points of the housekeeping connector are current set-points rather than voltage set-points. When an excess current condition occurs, or the current being drawn from the fuel cell stack is increasing and beginning to approach the excess current condition, the housekeeping power supply is disconnected to further reduce the current load on the fuel cell stack. The disconnect set-point current for the housekeeping supply is determined with reference to the specific characteristics and operating conditions of the fuel cell system.

The present invention also provides a method for stabilising the supply of electrical power from a fuel cell stack to a DC bus within a selected operating range, which method includes:
detecting a fuel cell current being drawn from the fuel cell stack by the DC bus; and
reducing an electrical power flow from the DC bus to a housekeeping power supply as required, based on a stabilisation signal representing the supply of electrical power being outside the selected operating range.

Typically, the housekeeping elements include a rechargeable battery bank to supply backup power to the other housekeeping elements when the power drawn by the housekeeping supply from the DC bus is limited by the control.

During the period wherein the housekeeping elements are at least partially disconnected from the DC bus, it is nevertheless important that the essential elements of the fuel cell system continue to operate. When disconnected from the DC bus, the housekeeping elements may continue to operate using electrical power from a rechargeable battery bank which is included among the housekeeping elements. The battery bank is able to operate the housekeeping elements temporarily until they are reconnected to the DC bus, whereafter the rechargeable battery bank recharges. The housekeeping elements are only disconnected from the DC bus on a temporary basis, e.g. a brief disconnection to balance short-term transient effects on the DC bus by other components in the system.

Fuel cell systems may operate sub-optimally when an under-current condition occurs, i.e. when the amount of reactive species supplied to the fuel cell stack is larger than that being required by the electrical loads on the fuel cell system. In a combined heat and power (CHP) production appliance incorporating a fuel cell system, the gaseous fuel that passes unused through the fuel cells is burnt in a downstream section of the system, i.e. part of the balance of plant, to generate heat. If, due to transient electrical effects, the electrical load on the fuel cell stack is dramatically reduced, there will be a corresponding sudden increase in the amount of unused fuel passing into downstream sections of the fuel cell system. This sudden and large increase in unused fuel downstream may cause undesirable sudden thermal changes which affect the overall efficiency and stability of the fuel cell system. It is preferable therefore to counteract this dramatic decrease in electrical load at the electrical level. In this embodiment of the present invention, if one or more of the power-drawing components of the electrical system suddenly reduce their electrical load on the DC bus, an alternative electrical load, in the form of a loadbank, is rapidly connected to the DC bus, thereby compensating for the other changes in electrical requirements. The aim of the loadbank is to provide a more stable electrical load the fuel cell when other components reduce their drawn current.

Accordingly, the present invention also provides a fuel cell stabilisation system for stabilising the supply of electrical power from a fuel cell stack to a DC bus, including a control configured to enable a loadbank to draw electrical power from the DC bus.

The present invention also provides a method for stabilising the supply of electrical power from a fuel cell stack to a DC bus within a selected operating range, which method includes:
detecting a DC bus voltage on the DC bus connected to the fuel cell stack; and
increasing an electrical power flow to a loadbank from the DC bus as required, based on a stabilisation signal representing the supply of electrical power being outside the selected operating range.

In a voltage-controlled system, the control includes:
a bus voltage sensor configured to sense a DC bus voltage on the DC bus representative of the supply of electrical power;
a comparator configured to compare the DC bus voltage to at least one selected set-point voltage defining the selected operating range, to generate the stabilisation signal; and
a variable control, controlled by the stabilisation signal of the comparator, configured to control supply of electrical power from the DC bus to the loadbank.

The loadbank is typically connected to the DC bus via a variable contact which closes (i.e. connects) when the voltage of the DC bus rises above a set level associated with the selected operating range. The voltage of the DC bus will rise when the amount of current being supplied by the fuel cell stack is greater than that being drawn by the normal load components on the DC bus. The connection set-point for the loadbank is predetermined and depends on the characteristics and operating conditions of the fuel cell system. The amount of current flowing into the loadbank from the DC bus is subsequently automatically reduced when the voltage of the DC bus falls back below the loadbank set-point; this occurs when the normal operating components resume drawing rated power, or the fuel delivered to the fuel cell stack is reduced to the new required level. The connection of the loadbank to the DC bus is through a variable control which can vary the power drawn from the DC bus substantially proportionally. This variation may be linearly or stepped.

The present invention also provides a method for stabilising the supply of electrical power from a fuel cell stack to a DC bus within a selected operating range, which method includes:
detecting a fuel cell current level being drawn from the fuel cell stack by the DC bus; and
increasing an electrical power flow to a loadbank from the DC bus as required, based on a stabilisation signal representing the supply of electrical power being outside the selected operating range.

In a current-controlled system, the control includes:
a fuel cell current sensor configured to sense a fuel cell electrical current supplied by the fuel cell stack representative of the supply of electrical power;
a comparator configured to compare the fuel cell electrical current to at least one selected set-point current defining the selected operating range, to generate the stabilisation signal; and
a variable control, controlled by the stabilisation signal of the comparator, configured to control supply of electrical power from the DC bus to the loadbank.

In a current-controlled embodiment, the loadbank is activated when the current drawn from the fuel cell reduces below a rated operating value associated with the selected operating range, which is determined with reference to the characteristics and operating conditions of the fuel cell system. In this way, the loadbank is able to ensure that an approximately constant amount of current is drawn from the fuel cell for any given rated operating condition.

The present invention also provides a fuel cell system including:
a fuel cell stack;
a DC bus; and
a fuel cell stabilisation system as described herein.

### DESCRIPTION OF THE DRAWINGS

Embodiments of the invention are hereinafter described, by way of non-limiting example only, with reference to the accompanying drawings in which:

FIG. 1 is a schematic layout of a voltage-controlled fuel cell stabilisation system;

FIG. 2 is a flow chart showing a method of voltage-controlled fuel cell stabilisation in the power supply connection controller of FIG. 1;

FIG. 3 is a flow chart showing a method of voltage-controlled fuel cell stabilisation in the housekeeping connection controller of FIG. 1;

FIG. 4 is a flow chart showing a method of voltage-controlled fuel cell stabilisation in the loadbank connection controller of FIG. 1;

FIG. 5 is schematic layout of the housekeeping elements of FIG. 1;

FIG. 6 is a schematic of the voltage-controlled fuel cell stabilisation system of FIG. 1, including a digital control board;

FIG. 7 is a schematic layout of a current-controlled fuel cell stabilisation system;

FIG. 8 is a schematic of the current-controlled fuel cell stabilisation system of FIG. 7, including a digital control board;

FIG. 9 is a flow chart showing a method of current-controlled fuel cell stabilisation in the power supply connection controller of FIG. 7;

FIG. 10 is a flow chart showing a method of current-controlled fuel cell stabilisation in the housekeeping connection controller of FIG. 7; and

FIG. 11 is a flow chart showing a method of current-controlled fuel cell stabilisation in the loadbank connection controller of FIG. 7.

### DETAILED DESCRIPTION OF PREFERRED EMBODIMENTS

Embodiments of the present invention provide systems for preventing or at least reducing instability and/or damage to fuel cell systems due to undesirable electrical load or operating conditions, including under-voltage and/or over-voltage, over-current and/or under-current, or excess unused fuel passing through a fuel cell stack.

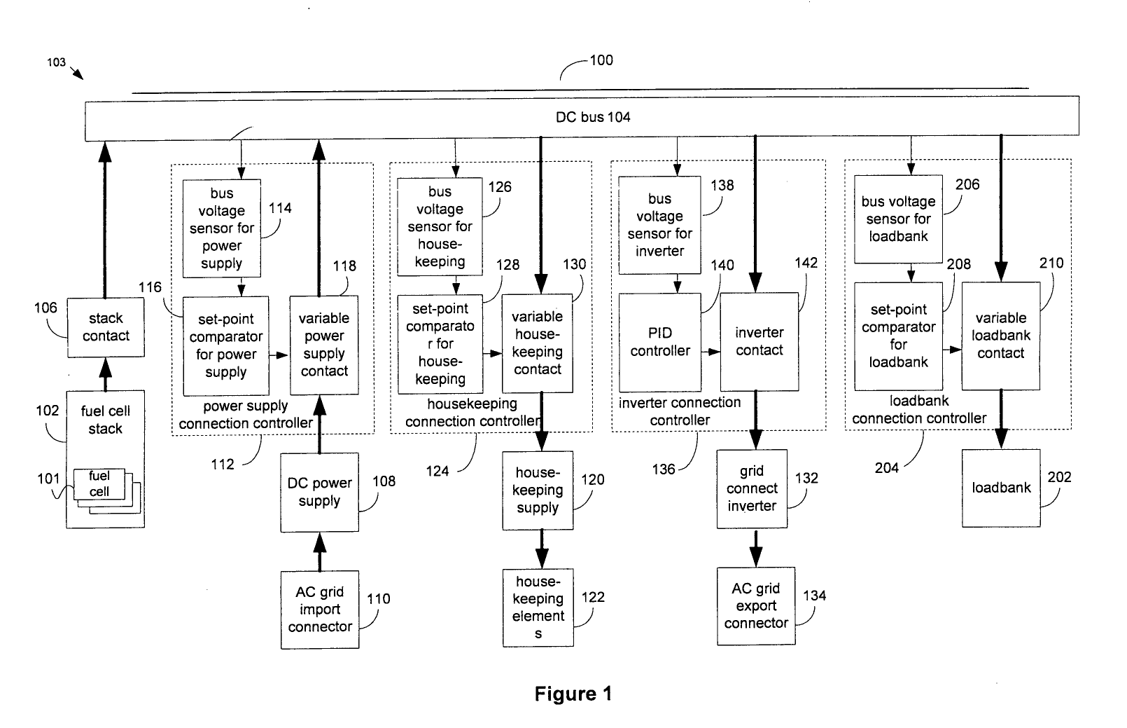

A fuel cell stabilisation system 100 is used in a fuel cell system 103, shown in FIG. 1, which includes a high-voltage DC bus 104 a fuel cell stack 102 containing fuel cells 101 for supplying the DC bus 104 with electrical power (via a variable stack contact 106). Electrical power can be drawn from the DC bus 104 by a housekeeping supply 120, a grid connect inverter 132, and a loadbank 202. The fuel cell system 103 may be for example the major operating portion of a combined heating and power (CHP) appliance of the general type supplied by Ceramic Fuel Cells Limited (170 Browns Road, Noble Park, Australia).

DC power is also able to be supplied to the DC bus 104 from the DC power supply 108, which in turn is able to draw power from the AC power grid via an AC grid import connector 110. The DC power supply 108 can be used to stabilise the current and voltage levels of the fuel cell stack 102 to within a preferred selected operating range. The DC power supply 108 is connected to the DC bus 104 via a power supply connection controller 112, which provides fuel cell stack stabilisation by generating a stabilisation signal representing that the supply of electrical power is outside the selected operating range.

In voltage-controlled embodiments, the power supply connection controller 112 includes a bus voltage sensor 114 for the power supply that continuously monitors the voltage of the DC bus 104. A set-point comparator 116 for the power supply compares the DC bus voltage, as sensed by sensor 114, with an internally-stored set-point value of voltage; this set-point is selected by a central control system and represents a turn-on value for the DC power supply 108. If the sensed DC bus voltage is equal to or below the set-point value, the set-point comparator 116 activates a variable power supply contact 118, and the DC power supply 108 proceeds to supply power to the DC bus 104. If the sensed DC bus voltage is above the set-point value in comparator 116, the variable power supply contact 118 will be de-activated and the DC power supply 108 will be disconnected from the DC bus 104. The set-point values define the selected operating range.

The DC power supply 108 is a Meanwell SP 500 power supply, having a unity power factor front end and internal intermediate HV bus and a secondary forward converter for 24 V DC output (at 20 Amps), rated at approximately 500 Watts. The DC power supply 108 is configured to have a reduced current limit, providing a maximum input power of approximately 400 W, thus providing an impedance limit for the high-voltage DC components. Additionally a step-down transformer in the DC power supply 108 is configured to provide the normal stack operation voltage range (i.e. 180 to 320 V DC).

The variable power supply contact 118 is in the form of a linear control block including a high speed on/off switch and a filter to linearise the current flow proportional to the block's switching frequency.

Combined heating and power (CHP) fuel cell systems require additional support components in addition to the fuel cell stack 102 for reliable and cost-effective operation, including housekeeping elements 122. The housekeeping supply 120, in FIG. 1, powers the housekeeping elements 122 and is connected to the DC bus 104, via a housekeeping connection controller 124, which provides fuel cell stabilisation. The housekeeping elements 122, also known as parasitic elements, include devices that support the operation of the fuel cell power system, including fuel pumps and cooling fans.

The housekeeping connection controller 124 can be used to stabilise the current and voltage levels of the fuel cell stack 102. In voltage-controlled embodiments, the housekeeping connection controller 124 includes a bus voltage sensor 126 for the housekeeping that continuously monitors the voltage of the DC bus 104. A set-point comparator 128 for the housekeeping compares the DC bus voltage (as sensed by sensor 126) with an internally-stored set-point value of voltage; this set-point is selected by a central control system and represents a turn-off value for the housekeeping 108. If the sensed DC bus voltage is equal to or below the set-point value, the set-point comparator 128 de-activates a variable housekeeping contact 130, and the housekeeping supply 120 is disconnected from the DC bus 104. If the sensed DC bus voltage is above the set-point value in comparator 128, the variable housekeeping contact 130 will be re-activated and the housekeeping supply 120 will re-commence drawing power from the DC bus 104.

The loadbank 202 is able to dissipate excess DC power through a cooled resistor bank and is connected to the DC bus 104 via a loadbank connection controller 204, which provides fuel cell stabilisation.

The loadbank connection controller 124 can be used to stabilise the current and voltage levels of the fuel cell stack 102. In voltage-controlled embodiments, the loadbank connection controller 204 includes a bus voltage sensor 206 for the loadbank that continuously monitors the voltage of the DC bus 104. A set-point comparator 208 for the loadbank compares the DC bus voltage, as sensed by sensor 206, with an internally-stored set-point value of voltage; this set-point is selected by a central control system and represents a turn-on value for the DC loadbank 202—if the sensed DC bus voltage is equal to or above the set-point value, the set-point comparator 208 activates a variable loadbank contact 210, and the DC loadbank 202 proceeds to draw power from the DC bus 104. If the sensed DC bus voltage is below the set-point value in comparator 208, the variable loadbank contact 210 will be de-activated and the DC loadbank 108 will be disconnected from the DC bus 104.

The grid connect inverter 132, in FIG. 1, is able to export power to the AC grid via an AC grid export connector 134, and is connected to the DC bus 104 via an inverter connection controller 136, which provides fuel cell stabilisation. The inverter connection controller 136 includes a bus voltage sensor 138 for the inverter that continuously monitors the voltage of the DC bus 104. A PID controller 140 for the inverter compares the DC bus voltage, as sensed by sensor 138, with an internally-stored set-point value of voltage; this set-point is selected by a central control system and represents a target value for the voltage on the DC bus 104. If the sensed DC bus voltage is equal to or below this set-point value, the PID controller 140 decreases the current flow through an inverter contact 142, and the grid connect inverter 132 draws less current from the DC bus 104. If the sensed DC bus voltage is above the set-point value in the PID controller 140, the inverter contact 142 will be increase current flow and the grid connect inverter 120 will draw more power from the DC bus 104.

The inverter connection controller 136 is controlled by serial communications, and valid communications may take several seconds to effect a normal shutdown. Furthermore, the inverter connection controller 136 may require certain time-consuming shut-down protocols to be observed. If the DC bus voltage drops, the inverter 132 may still continue to draw power from the DC bus for a non-negligible period of time.

In steady state operation, the voltage on the DC bus 104 remains at a steady operating level, and the connections of the contacts, in voltage-controlled embodiments, are as follows:
variable stack contact 106:
   connected
   (stack 102 supplies power to the DC bus 104)
variable power supply contact 118:
   disconnected
   (DC power supply 108 does not supply power)
variable housekeeping contact 130:
   connected
   (housekeeping supply 120 draws power from the DC bus 104) variable loadbank contact 210:
   disconnected
   (loadbank 202 does not draw power).

The connection controllers (112, 124, 136 and 204) are set to operate when the voltage on the DC bus varies from its steady operating level due to an unexpected system event. The different variable controls, or variable contacts, 106, 118 130 and 210, will activate/de-activate according to the different set-points in comparators 116, 128, 140 and 208. The set points are determined by a central system. In an example system, for a steady-state operating voltage of approximately 242.5 V DC, the set-point values for the DC bus voltage are approximately:

| Set-Point | DC Bus Voltage (V) |
|---|---|
| loadbank (over-volt protection): | 245 |
| inverter (under-volt protection): | 240 |
| power supply (under-volt protection): | 235 |
| housekeeping (under-volt protection): | 230 |

An example system will have a steady-state operating voltage that can vary from approximately 180 to 320 V DC. However, the operating voltage can only be varied over this range at a speed much slower than the speed required for stabilisation and protection of the fuel cell from adverse electrical events. The selection of the steady-state operating voltage and the corresponding set-points is provided by a central control system 904.

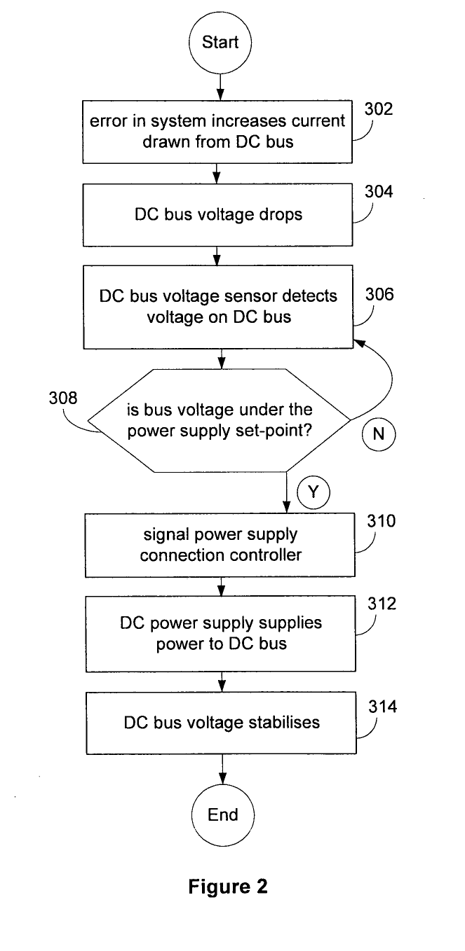

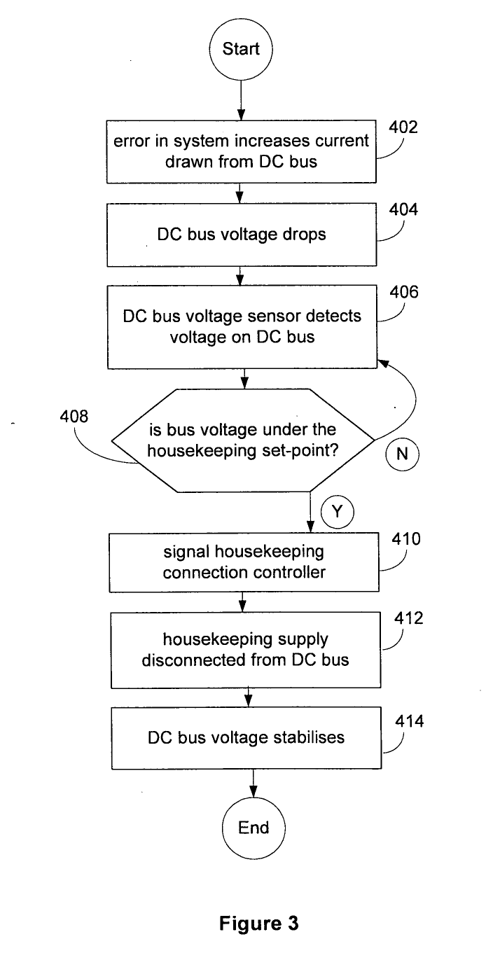

FIG. 2 is a flow chart of a method of voltage-controlled fuel cell stabilisation performed by the power supply connection controller 112. The system starts in a steady operating condition, with power being supplied to the DC bus 104 from the fuel cell stack 102, power being drawn by the housekeeping supply 120 and the grid connect inverter 132, no power being supplied by the DC power supply 108 and no power being drawn by the loadbank 202. At step 302, an error in the system causes excess current to be drawn from the fuel cell stack 102; this error may include a drop in fuel supplied to the stack, or a short circuit in one of the electrical loads, or a change of the AC power grid. At step 304, the excess current causes the voltage of the DC bus 104 to drop, which is detected by the bus voltage sensor 114 at step 306. At step 308, the set-point comparator 116 compares the measured voltage on the DC bus to power supply set-point: if the DC voltage has dropped to be equal to or less than the power supply set point, the comparator 116 activates the variable power supply contact 118 at step 310, and the DC power supply 108 commences supplying power to the DC bus 104 at step 312, thereby stabilising its voltage at step 314. Preferably, the method in FIG. 3 occurs rapidly (i.e. in a few milliseconds or less), with the set-point comparator 116 operating at a frequency in the order of a few kilohertz. The DC power supply 108 will be able to stabilise the DC bus voltage in most conditions; this may not be possible, for example, if the external AC power grid has collapsed, in which case there would be no power source for the DC power supply 108.

FIG. 3 is a flow chart of a method of voltage-controlled fuel cell stabilisation performed by the housekeeping connection controller 124. The system starts in a steady operating condition, with power being supplied to the DC bus 104 from the fuel cell stack 102, power being drawn by the housekeeping supply 120 and the grid connect inverter 132, no power being supplied by the DC power supply 108 and no power being drawn by the loadbank 202. At step 402, an error in the system causes excess current to be drawn from the fuel cell stack 102; this error may include a drop in fuel supplied to the fuel cell stack 102, or a short circuit in one of the electrical loads, or a change in the AC power grid. At step 404, the excess current causes the voltage of the DC bus 104 to drop, which is detected by the bus voltage sensor 126 at step 406. At step 408, the set-point comparator 128 compares the measured voltage on the DC bus to the housekeeping set-point: if the DC voltage has dropped to be equal to or less than the housekeeping set point, the comparator 128 activates the variable housekeeping contact 130 at step 410, and the housekeeping supply 120 is disconnected from the DC bus 104; this disconnection will reduce the power being drawn from the DC bus 104 and may therefore stabilise the DC bus voltage at step 414. The method in FIG. 3 occurs as within a few milliseconds. When the power drawn from the DC bus 104 is limited at step 412, the housekeeping elements 122 may continue to operate from power supplied by a re-chargeable battery bank 704 included in the housekeeping elements.

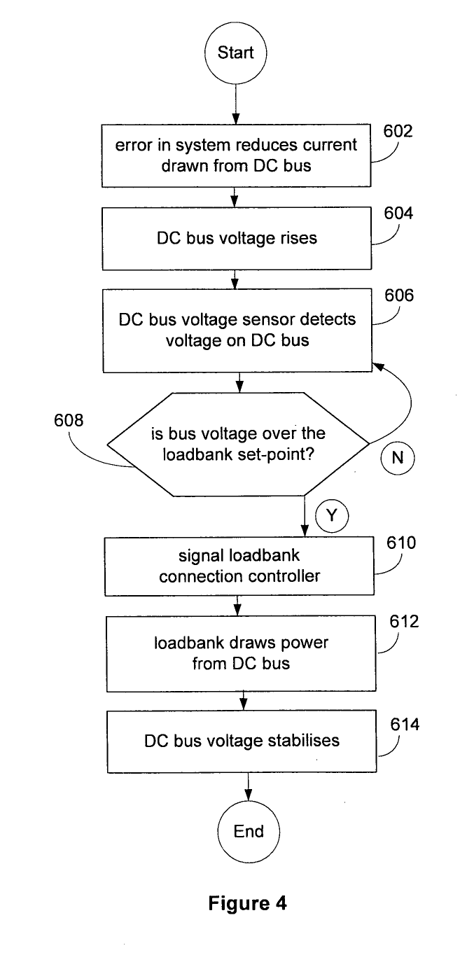

FIG. 4 is a flow chart of a method of voltage-controlled fuel cell stabilisation performed by the loadbank connection controller 204. The system starts in a steady operating condition, with power being supplied to the DC bus 104 from the fuel cell stack 102, power being drawn by the loadbank supply 120 and the grid connect loadbank 132, no power being supplied by the DC power supply 108 and no power being drawn by the loadbank 202. At step 602, an error in the system causes less current to be drawn from the DC bus 104, and therefore the fuel cell stack 102 is ‘burning’ more fuel than required; this error may include a sudden increase in fuel supplied to the stack, or a an open circuit in one of the electrical loads (sudden disconnection from the DC bus), or a collapse of the AC power grid (thus shutting off export of power to the AC grid). At step 604, the drop in current supplied causes the voltage of the DC bus 104 to rise, which is detected by the bus voltage sensor 206 at step 606. At step 608, the set-point comparator 208 compares the measured voltage on the DC bus to the loadbank set-point: if the DC voltage has risen to be equal to or more than the loadbank set point, the comparator 208 activates the variable loadbank contact 210 at step 610, and the loadbank 202 is connected to the DC bus 104; this connection will draw power from the DC bus 104 and may therefore stabilise the DC bus voltage at step 614. The method in FIG. 4 occurs as rapidly as possible, and typically within a few milliseconds.

Advantageously, having stability and under- and over-voltage protection provided by one or more connection controllers, for example 112, 124, 136 and 204, enables the system to be constructed without a sensor and protection system between the fuel cell stack 102 and the DC bus 104. Such an additional protection system would be a source of loss. Not having such an additional protection system permits the fuel cell stack 102 to be directly connected to the DC bus 104, which is in turn directly connected to the electrical loads 106, thus increasing the efficiency of the system.

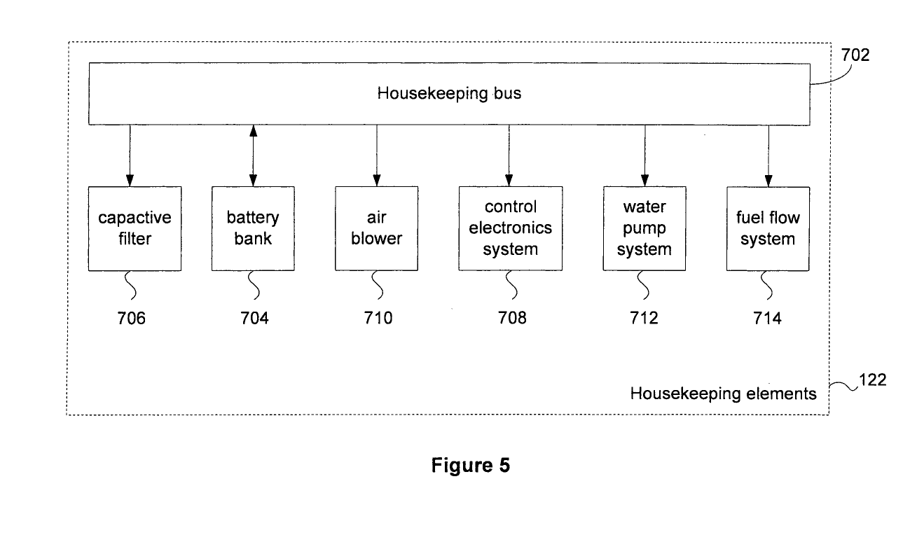

The housekeeping elements 122, shown in FIG. 5, are powered from a housekeeping bus 702, which derives power from the housekeeping supply 120. The housekeeping elements 122 include a battery bank 704, which includes rechargeable batteries for maintaining a consistent power supply on the housekeeping bus, despite variations in the power from the housekeeping supply 308. The housekeeping elements 302 also include: an EMC filter 706, which may be a capacitor (for reducing transient voltages which may cause electromagnetic interference); power for the control electronics system 708; an air blower 710; a water pump system 712; and a fuel flow system 714. Other housekeeping elements 122 may include a gas safety system, a central control system processor, sensors, valves and process control elements.

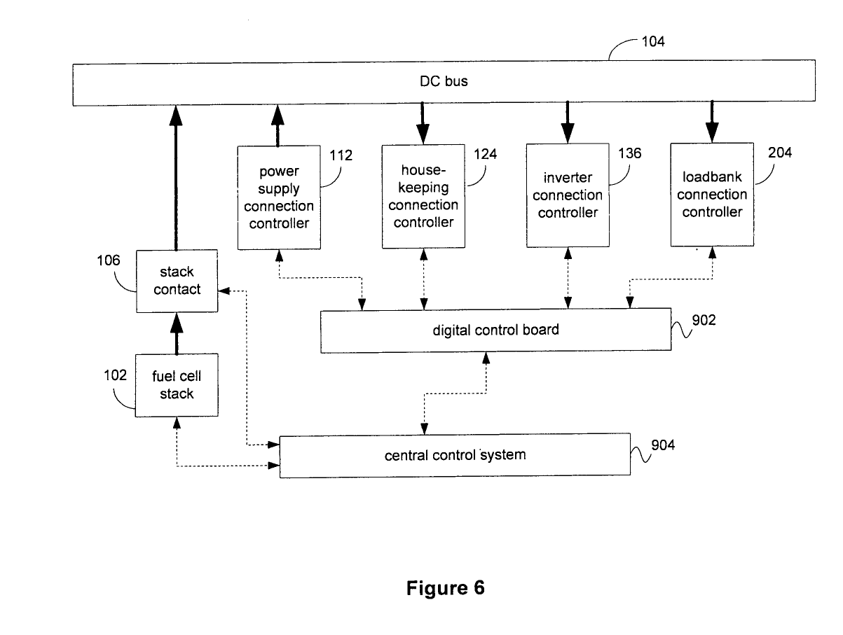

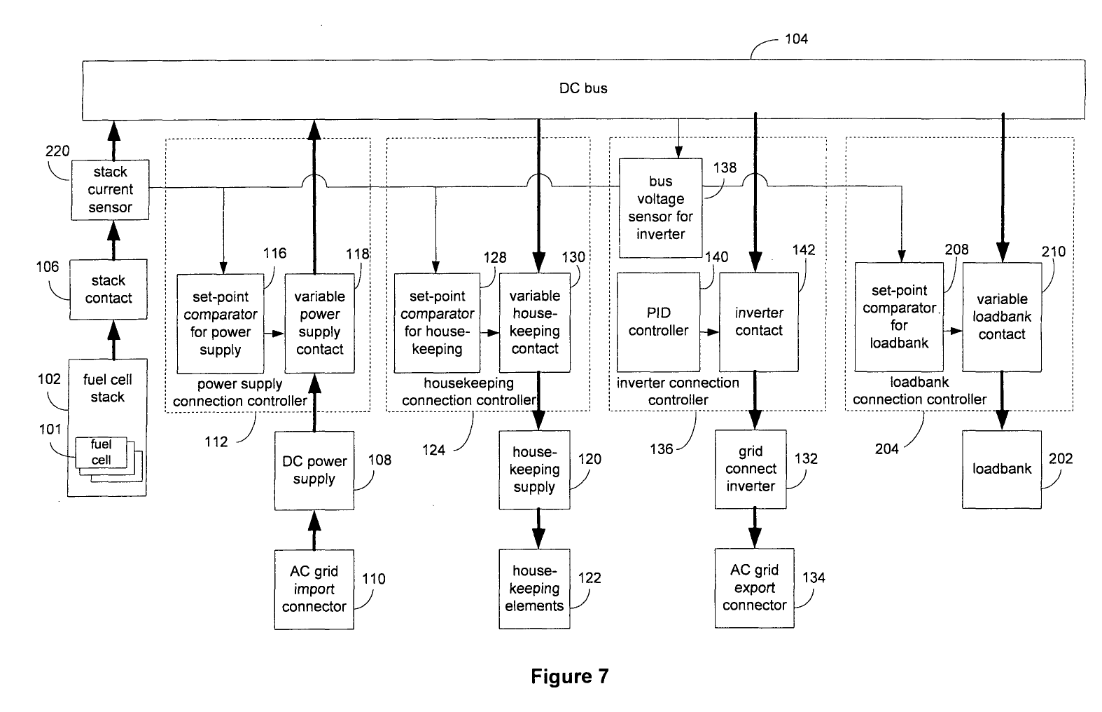

FIGS. 6 and 7 together include a more-detailed schematic diagram of FIGS. 1 and 2, further including a digital control board 902 and a central control system 904. The central control system 904 selects the operating voltage of the fuel cell stack 102 and thus the DC bus 104. The control system 904 also selects the set points of the comparators 116, 128, 140 and 208 and sets these values via the digital controller board 902. In an example system, the connection controllers (112, 124, 136 and 204) are realised using PID ('Proportional-Integral-Derivative') control units.

In the voltage-controlled fuel cell stabilisation system described above, under- and over-voltage of the common DC bus 104 is used as a common means of individually synchronising each DC bus element (DC power supply 108, housekeeping supply 120, inverter 132 and loadbank 202). The voltage mode of control may be particularly useful when a high linear electrical resistance dominates the fuel cell 101. However, if the fuel cell stack 102 has low or non-linear electrical resistance, a current-controlled fuel cell stabilisation system may be preferable.

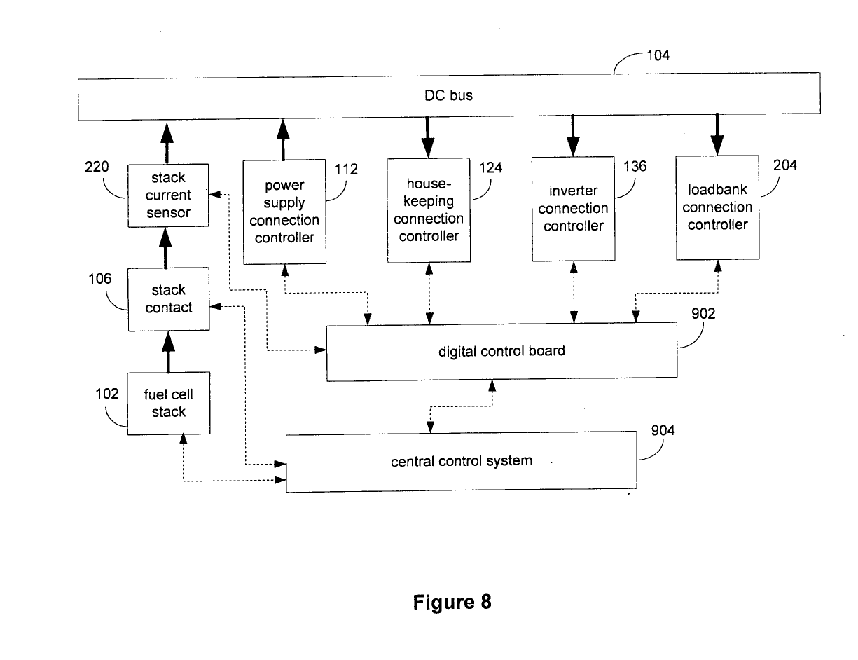

In a current-controlled fuel cell stabilisation system, shown in FIGS. 7 and 8, a stack current sensor 220 monitors the current flowing through the fuel cell stack 102. The stack current sensor 220 is in the form of an ammeter. The currents drawn by the DC power supply 108, the housekeeping supply 120 and the loadbank 202 are controlled by respective comparators 116, 128 and 208 that are sensitive to pre-determined current set-point values. Some example current set-points, based on particular operating conditions of the fuel cell system, are:
Connect the DC power supply 108 when the stack current (from stack current sensor 220) rises above 5.0 Amps;
Disconnect the housekeeping supply 120 when the stack current (from stack current sensor 220) rises above 5.5 Amps; and
Connect the loadbank 202 when the stack current (from stack current sensor 220) falls below 4.0 Amps.

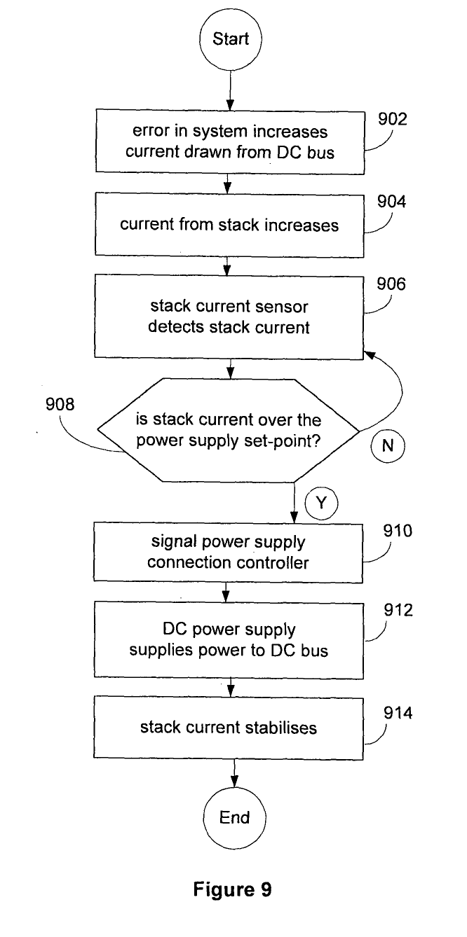

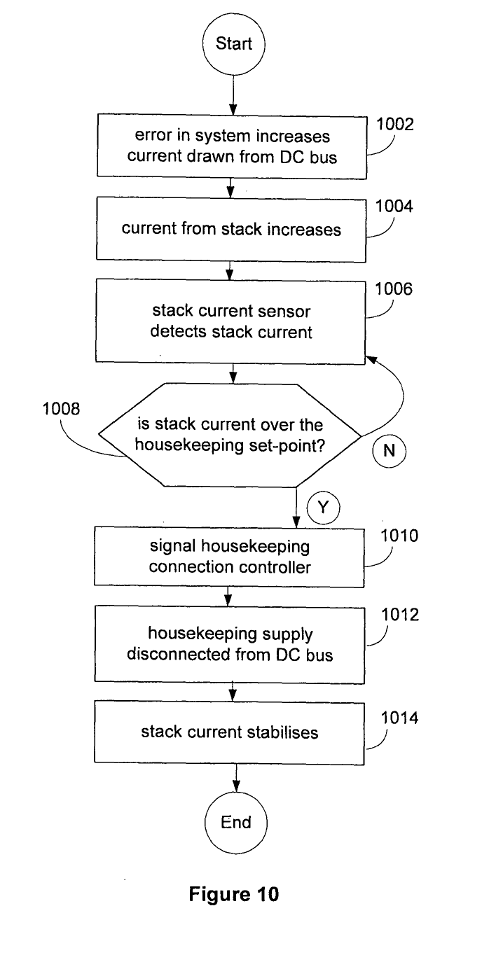

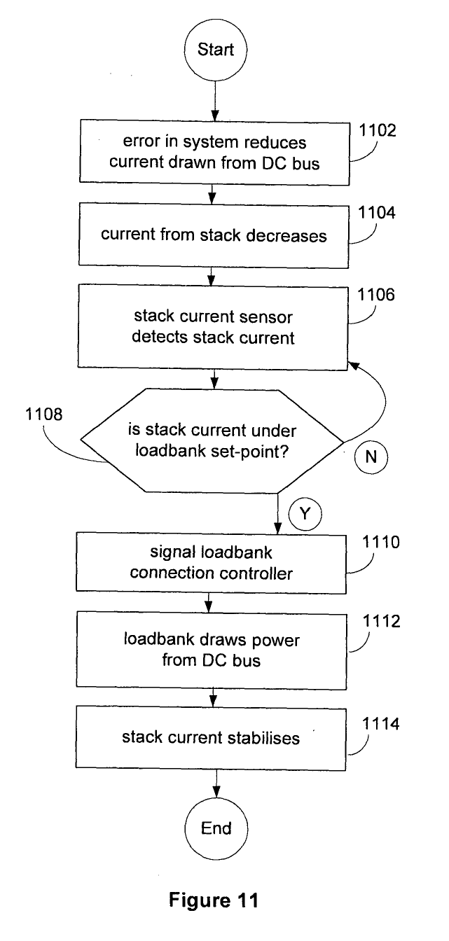

The current-controlled fuel cell stabilisation system operates as shown in FIGS. 9 to 11. For example, the grid connect inverter 132 might be set to 4.5 A of current draw. The DC power supply 108 is off, the housekeeping supply 120 is on, and the loadbank 202 is off (i.e. disconnected). If the current being drawn from the fuel cell stack 102 rises above 5.0 A due to an increase in load (possibly by the grid connect inverter 132), then the power supply comparator 116 would connect the DC power supply 108. If the current being drawn from the fuel cell stack 102 rises above 5.5 A, then the housekeeping supply 120 is disconnected via the housekeeping comparator 128. If the inverter 132 stops operating, or the stack load current drops below 4.0 A for some other reason, then the loadbank comparator 208 connects the loadbank 202 to maintain the current being drawn from the fuel cell stack 102 at 4.0 A.

A current-controlled fuel cell stabilisation system takes into account the combined current and voltage characteristics of the fuel cell stack 102. If the stack voltage decays, the operating current set-points in comparators 116, 128 and 208 are adjusted by a central control system 904 to compensate for the change in stack resistance parameters (such as I²R losses, described in this example).

The advantages of the present invention include rapid means of stabilising the output voltage and current the fuel cell 101, or fuel cells in a fuel cell stack 102, from adverse current and voltage conditions, including: over-voltage, when the fuel cell is producing more current than is being drawn by the electrical system; and under-voltage, when the fuel cell 101 is producing insufficient current. These adverse conditions may directly or indirectly damage the fuel cell 101, or cause instability and inefficient operation, through over-heating, oxidation or reduction of the fuel cell components or associated fuel processing systems.

An advantage of the fuel cell stabilisation system is buffering of rapid changes in the load of the DC bus 104. By substantially compensating for rapid load changes, the fuel cell stabilisation system allows the overall control system to be simplified, with slower and more stable time-response characteristics. By reducing the effects of load changes on a fuel cell system, the frequency and amplitude of thermal stresses occurring in the fuel cell system are reduced, thereby promoting the longevity of the fuel cell system. Furthermore, the fuel cell stabilisation system may permit a reduction in the overall complexity and cost of a fuel cell system.

It is to be appreciated that the embodiments of the invention described above with reference to the accompanying drawings have been given by way of example only and that modification and additional components may be provided to enhance the performance of the apparatus.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### PARTS LIST FOR THE DRAWINGS

| | |
|---|---|
| fuel cell stabilisation system | 100 |
| fuel cell | 101 |
| fuel cell stack | 102 |
| fuel cell system | 103 |
| DC bus | 104 |
| variable stack contact | 106 |
| DC power supply | 108 |
| AC grid import connector | 110 |
| power supply connection controller | 112 |
| bus voltage sensor | 114 |
| set point comparator | 116 |
| variable power supply contact | 118 |
| housekeeping supply | 120 |
| power housekeeping elements | 122 |
| housekeeping connection controller | 124 |
| bus voltage sensor | 126 |
| set point comparator | 128 |
| variable housekeeping contact | 130 |
| grid connect inverter | 132 |
| grid export connector | 134 |
| inverter connection controller | 136 |
| bus voltage sensor | 138 |
| PID controller | 140 |
| inverter contact | 142 |
| loadbank | 202 |
| loadbank connection controller | 204 |
| bus voltage sensor | 206 |
| set point comparator | 208 |
| variable loadbank contact | 210 |
| housekeeping bus | 702 |
| battery bank | 704 |
| housekeeping supply | 308 |
| housekeeping elements | 302 |
| EMC filter | 706 |
| control electronics system | 708 |
| air blower | 710 |
| water pump system | 712 |
| fuel flow system | 714 |
| digital control board | 902 |
| central control system | 904 |

1. A fuel cell stabilization system for stabilizing the supply of electrical power from a fuel cell stack to a DC bus within a selected operating range, comprising:
a DC power supply; and
a control configured to enable the DC power supply to supply electrical power to the DC bus based on a stabilization signal representing the supply of electrical power being outside the selected operating range.

2. A fuel cell stabilization system as claimed in claim 1, wherein the control comprises:
a bus voltage sensor configured to sense a DC bus voltage on the DC bus representative of the supply of electrical power;
a comparator configured to compare the DC bus voltage to at least one selected setpoint voltage defining the selected operating range, to generate the stabilization signal; and
a variable control, controlled by the stabilization signal of the comparator, configured to control the supply of electrical power to the DC bus.

3. A fuel cell stabilization system as claimed in claim 1, wherein the control comprises:
a fuel cell current sensor configured to sense a fuel cell electrical current supplied by the fuel cell stack representative of the supply of electrical power;
a comparator configured to compare the fuel cell electrical current to at least one selected set-point current defining the selected operating range, to generate the stabilization signal; and
a variable control, controlled by the stabilization signal of the comparator, configured to control the supply of electrical power to the DC bus.

4. A fuel cell stabilization system as claimed in claim 1, wherein the DC power supply is powered at start-up by a power grid.

5. A fuel cell stabilization system for stabilizing the supply of electrical power from a fuel cell stack to a DC bus within a selected operating range, comprising a control configured to limit electrical power drawn from the DC bus by a housekeeping supply, which is configured to power one or more housekeeping elements, based on a stabilization signal representing the supply of electrical power being outside the selected operating range.

6. A fuel cell stabilization system as claimed in claim 5, wherein the control comprises:
a bus voltage sensor configured to sense a DC bus voltage on the DC bus representative of the supply of electrical power;
a comparator configured to compare the DC bus voltage to at least one selected setpoint voltage defining the selected operating range, to generate the stabilization signal; and
a variable control, controlled by the stabilization signal of the comparator, configured to limit electrical power drawn from the DC bus by the housekeeping supply.

7. A fuel cell stabilization system as claimed in claim 5, wherein the control comprises:
a fuel cell current sensor configured to sense a fuel cell electrical current supplied by the fuel cell stack representative of the supply of electrical power;
a comparator configured to compare the fuel cell electrical current to at least one selected set-point current defining the selected operating range, to generate the stabilization signal; and
a variable control, controlled by the stabilization signal of the comparator, configured to limit electrical power drawn from the DC bus by the housekeeping supply.

8. A fuel cell stabilization system as claimed in claim 5, further comprising a rechargeable battery bank configured to supply backup power to the other housekeeping elements when the power drawn by the housekeeping supply from the DC bus is limited by the control.

9. A fuel cell stabilization system for stabilizing the supply of electrical power from a fuel cell stack to a DC bus, comprising a control configured to enable a loadbank to draw electrical power from the DC bus.

10. A fuel cell stabilization system as claimed in claim 9, wherein the control comprises:
a bus voltage sensor configured to sense a DC bus voltage on the DC bus representative of the supply of electrical power;
a comparator configured to compare the DC bus voltage to at least one selected set-point voltage defining the selected operating range, to generate the stabilization signal; and
a variable control, controlled by the stabilization signal of the comparator, configured to control supply of electrical power from the DC bus to the loadbank.

11. A fuel cell stabilization system as claimed in claim 9, wherein the control comprises:
a fuel cell current sensor configured to sense a fuel cell electrical current supplied by the fuel cell stack representative of the supply of electrical power;
a comparator configured to compare the fuel cell electrical current to at least one selected set-point current defining the selected operating range, to generate the stabilization signal; and
a variable control, controlled by the stabilization signal of the comparator, configured to control supply of electrical power from the DC bus to the loadbank.

12. A method for stabilizing the supply of electrical power from a fuel cell stack to a DC bus within a selected operating range, which method comprises:
detecting a DC bus voltage on the DC bus; and
increasing an electrical power flow to the DC bus from a DC power supply as required, based on a stabilization signal representing the supply of electrical power being outside the selected operating range.

13. A method for stabilizing the supply of electrical power from a fuel cell stack to a DC bus within a selected operating range, which method comprises:
detecting a fuel cell current being drawn from the fuel cell stack by the DC bus; and
increasing an electrical power flow to the DC bus from a DC power supply as required, based on a stabilization signal representing the supply of electrical power being outside the selected operating range.

14. A method for stabilizing the supply of electrical power from a fuel cell stack to a DC bus within a selected operating range, which method comprises:
detecting a DC bus voltage on the DC bus connected to the fuel cell stack; and
reducing an electrical power flow from the DC bus to a housekeeping power supply as required, based on a stabilization signal representing the supply of electrical power being outside the selected operating range.

15. A method for stabilizing the supply of electrical power from a fuel cell stack to a DC bus within a selected operating range, which method comprises:
detecting a fuel cell current being drawn from the fuel cell stack by the DC bus; and
reducing an electrical power flow from the DC bus to a housekeeping power supply as required, based on a stabilization signal representing the supply of electrical power being outside the selected operating range.

16. A method for stabilizing the supply of electrical power from a fuel cell stack to a DC bus within a selected operating range, which method comprises:
detecting a DC bus voltage on the DC bus connected to the fuel cell stack; and
increasing an electrical power flow to a loadbank from the DC bus as required, based on a stabilization signal representing the supply of electrical power being outside the selected operating range.

17. A method for stabilizing the supply of electrical power from a fuel cell stack to a DC bus within a selected operating range, which method comprises:
detecting a fuel cell current level being drawn from the fuel cell stack by the DC bus; and increasing an electrical power flow to a loadbank from the DC bus as required, based on a stabilization signal representing the supply of electrical power being outside the selected operating range.

18. A fuel cell system comprising:
a fuel cell stack;
a DC bus; and
a fuel cell stabilization system as claimed in claim 1.

19. A fuel cell system as claimed in claim 18, further comprising a DC-to-AC inverter electrically connected to the DC bus for exporting electrical power from the fuel cell stack.

20. A fuel cell system as claimed in claim 18, further comprising an EMC filter electrically connected to the DC bus for reducing electromagnetic noise and transient voltages on the DC bus.
